(19) United States
(12) Patent Application Publication
(10) Pub. No.: US 2007/0008142 A1
(43) Pub. Date: Jan. 11, 2007

(54) Security key case

(76) Inventors: Matt Crowe, St. Paul, MN (US); Patrick Crowe, St. Louis Park, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/177,241

(22) Filed: Jul. 8, 2005

(51) Int. Cl. G08B 13/14

(52) U.S. Cl. 340/572.8

(57) ABSTRACT

In some embodiments, materials and methods of making and using a security key case having a plastic shell that encases a proximity access transponder for communication with a proximity access transponder reader and a head of a key. Teeth of the key project from the shell for unlocking a lock. A user employs the proximity access transponder to gain entrance to a common area of a facility and then uses the lock to gain access to a limited use area. In other embodiments, the application describes a method of making a security key case by providing a shell having two members that define a slot, a key having a head portion and a shaft with teeth for unlocking a lock, and at least one proximity access transponder for communication with at least one proximity access transponder reader, placing the proximity access transponder into the shell, placing the shaft into the shell with the shaft being disposed in the slot, and closing the shell to encase the proximity access transponder and the head of the key, with teeth of the key projecting from the shell.

### FIELD OF THE INVENTION

The field of the invention relates to locks actuated with a key, electronic identification systems permitting access to an area, and casings that include both the key and the requisite electronic access information.

### BACKGROUND

Access to buildings is increasingly being controlled by electronic devices that recognize an electronic code in a card or other device carried by a user that wishes to access the building. In some cases, the card carried by the user has a proximity access transponder and the electronic device for controlling building access is a proximity access transponder reader. The user places the card in the proximity of the reader, the reader verifies that the card has the appropriate code or other electronic identification, and actuates a mechanism to allow the door or other access into the building to be opened for the user. The user then enters the building and may then use a key to gain access to a room or other area in the building.

### SUMMARY OF THE INVENTION

Users must carry an increasing number of cards that have a proximity access transponder so they can gain access to their place of work, home or dwelling, exercise facility, or other facilities. And, when a key is further required to use or access the facility, the appropriate key must also be provided. What is needed is a simpler security system that more conveniently manages the proximity access transponder and keys for the user.

Accordingly, certain embodiments herein describe security systems and assemblies that unite a proximity access transponder and a key into one compact case. For example, building access may be controlled so that a proximity access transponder is required to gain access into a common area and a key is required to gain access into private areas, and the user may be provided with a single assembly, such as a compact plastic key carrier case, that unites the transponder and the key. The user can then locate their key carrier and, because the key is unified with the appropriate transponder, use it to access both the common area and the private area.

Some embodiments relate to a security key case comprising a unitary plastic shell that encases a proximity access transponder for communication with a proximity access transponder reader and a head of a key, with teeth of the key projecting from the shell for unlocking a lock.

Some embodiments relate to a method of making a security key case comprising providing a shell having two members that define a slot, a key having a head portion and a shaft with teeth for unlocking a lock, and a proximity access transponder for communication with a proximity access transponder reader and a head of a key, placing the proximity access transponder into the shell, placing the shaft into the shell with the shaft being disposed in the slot, and closing the shell to encase the proximity access transponder with teeth of the key projecting from the shell.

Some embodiments relate to a security system comprising a proximity access transponder reader that controls access to a common area of a facility, a lock that controls access from the common area into a limited access area, and a control assembly comprising a shell that encases a proximity access transponder that communicates with the proximity access transponder reader to allow access into the common area and a head of a key that fits the lock to allow access into the limited access area.

Some embodiments relate to a method of assembling a security system comprising providing a proximity access transponder reader that controls access to a common area of a facility, a lock that controls access from the common area into a limited access area, and a control assembly comprising a shell that encases a proximity access transponder that communicates with the proximity access transponder reader to allow access into the common area, placing a head of a key that fits the lock into a shell, and placing a proximity access transponder that communicates with the proximity access transponder reader into the shell. The shell may be permanently or reversibly locked.

### BRIEF DESCRIPTION OF THE FIGURES

FIG. 1 depicts a security system layout for a portion of a building having its access controlled by combinations of proximity transponder readers and keys;

FIG. 2A is a perspective view of a security key case;

FIG. 2B is a perspective view of the assembly of FIG. 2A showing a shift between open and closed positions;

FIG. 2C is a perspective view of the assembly of FIG. 2A, shown the assembly in the closed position;

FIG. 3A is an elevated view of the embodiment of FIG. 2A;

FIG. 3B is a plan view of the embodiment of FIG. 3A, with a view as indicated by arrow B;

FIG. 3C is an elevated view of the embodiment of FIG. 3A, with a view as indicated by arrow C;

FIG. 4A is a plan view of a proximity access transponder;

FIG. 4B is an elevated view of the proximity access transponder of FIG. 4A; and

FIGS. 5A and 5B depict an alternative embodiment of the invention.

FIG. 6 depicts an alternative embodiment of the invention.

### DETAILED DESCRIPTION OF THE DRAWINGS

A single compact assembly referred to herein as a security key case can be used to hold both a key and a proximity access transponder, both of which are needed to gain access to controlled areas, facilities, and/or devices. For example, a key is placed into a case that has a proximity access transponder, with the teeth of the key still being exposed. In the instance of an apartment building with a common area that is accessed with the proximity access transponder and private apartments accessed by the tenants via their respective keys, the user employs the security key case to access both the common area and the tenant's apartment.

Many facilities can be equipped with some or all of their spaces to be accessed using a security key case. Examples of such facilities include apartment buildings, condominiums, single family homes, hotels, schools, large passenger ships, commercial ships, cruise ships, office buildings, storage facilities, housing developments, gated communities, military bases, elevators, and other areas where both proximity access transponder readers and keyed locks are used for access. A security key case may also be useful for devices requiring access control such as computers and vehicles. The security key case may also be used for access control of a combination of facilities and devices such as a vehicle in combination with the person's dwelling and/or restricted parking area.

In some embodiments, the proximity access transponder is used to access common areas and a key is used to access limited-access areas or a residential dwelling. The use of a common area is typical in large facilities that have many users that share certain areas but have exclusive use of other areas. For example, a hallway in an apartment building is a common area while an apartment in that building is a residential dwelling area. A residential dwelling is a domicile, e.g., an apartment or condominium. A lobby in an office building is a common area while a suite of offices rented by a tenant in that building is a limited-access area. Thus, a common area is accessible by most users of a facility and a restricted-access area is accessible only by a subgroup of the users of the facility. Therefore, a user of such a facility may be equipped with a security key case to access both the common area and the limited-access area of a facility.

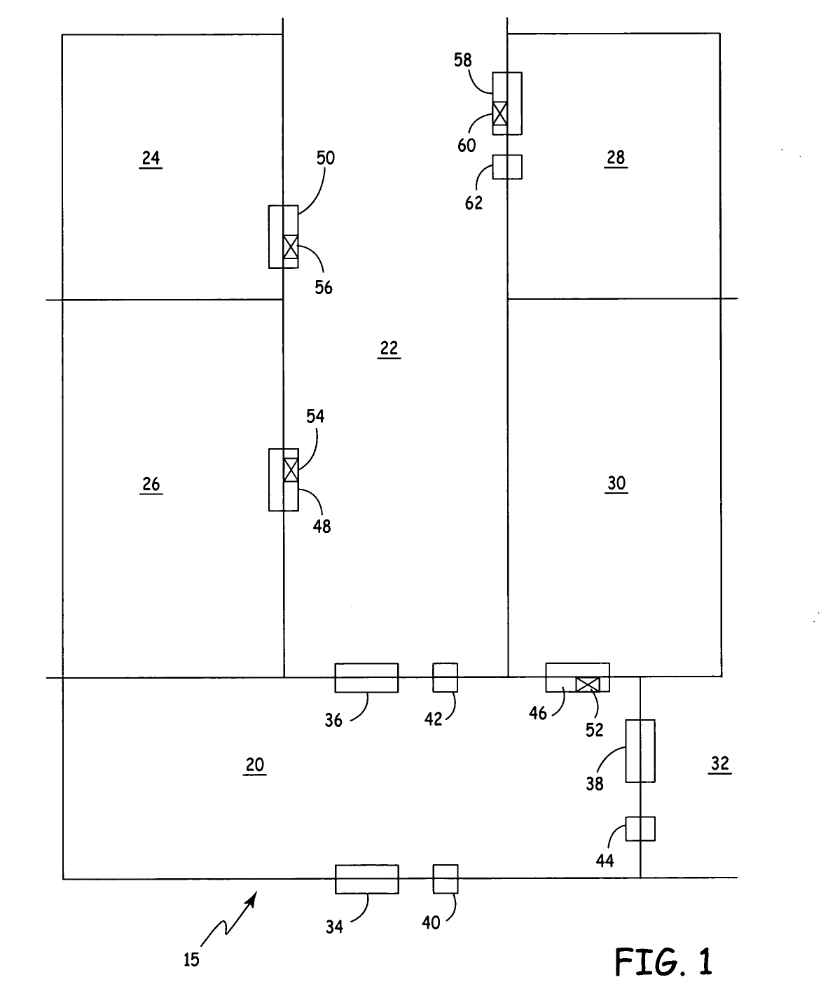

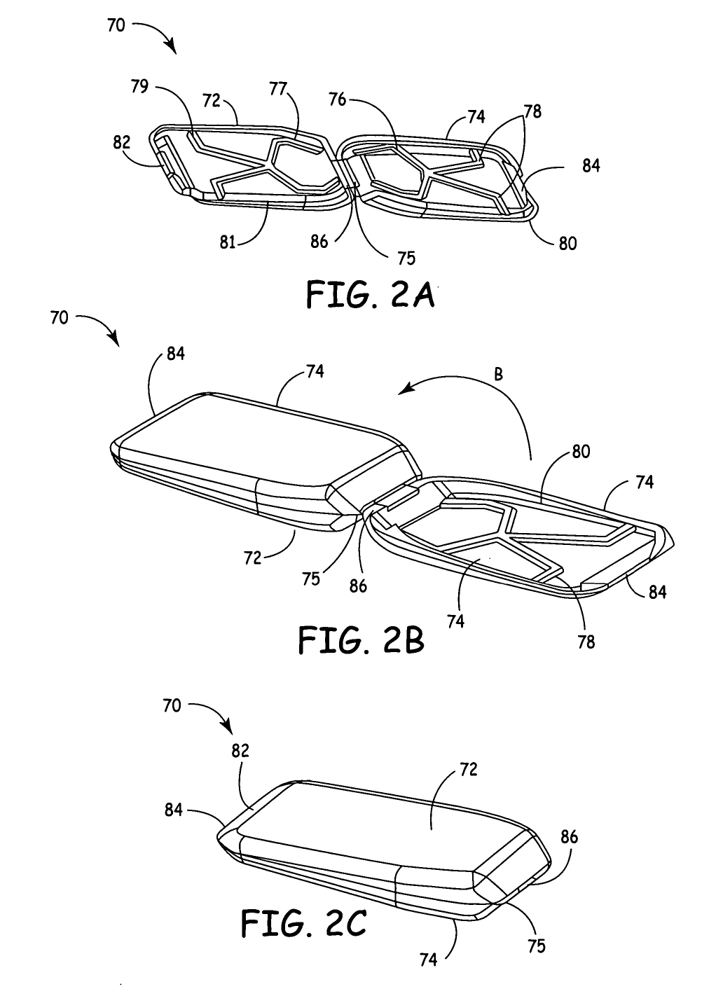

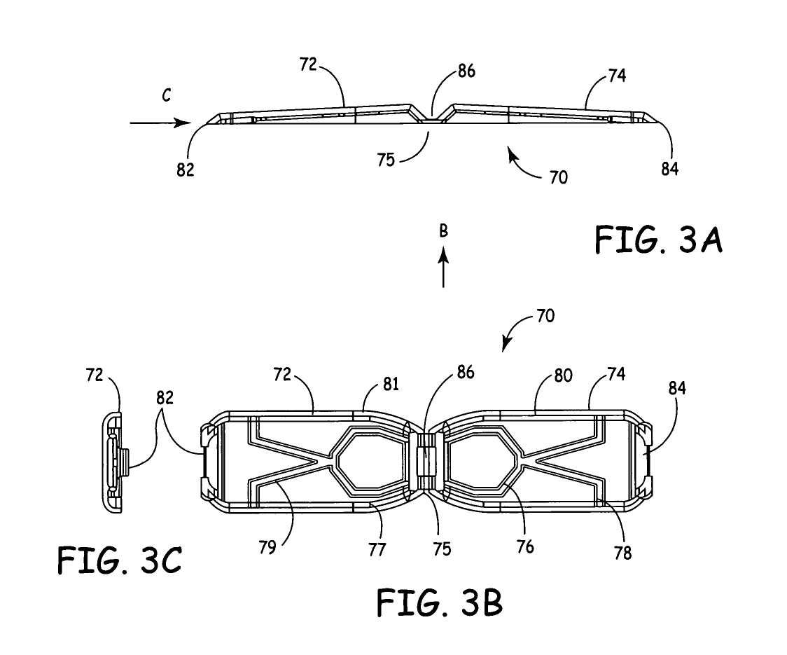

In some embodiments, a facility can be configured with devices that control access to different areas of the facility so that this security key case can be employed. Referring to FIG. 1, for example, a facility 15 has entryway 20, hallway 22, rooms 24, 26, 28, 30, and space 32. Door 34 to facility 15 is controlled by proximity access transponder reader 40. Door 36 between entryway 20 and hallway 22 is controlled by proximity access transponder reader 42. Door 38 between entryway 20 and space 32 is controlled by proximity access transponder reader 44. Doors 46, 48, and 50 are controlled by locks 52, 54, 56 respectively. Door 58 is controlled by both lock 60 and proximity access transponder reader 62. A manager provides a user with a single security key case, e.g., as in FIGS. 2 or 3, with a key and transponder(s) chosen by the manager. The security key case has both a key to the room(s) that the manager wishes the user to be able to access with the key, and also a proximity access transponder that communicates with at least one of the readers. The communication provides information that allows the user to pass through the door controlled by the reader. The manager selects the keys and transponder(s) to control the user's access to the spaces.

In some embodiments, a facility can be configured with multiple levels of clearance. For example, in the building referenced in FIG. 1, there may people with three levels of clearance to the facility 15. People with the lowest level of clearance may only be able to access the entryway 20 of the facility 15 from space 32 through door 38 by using the security key case containing a proximity access transponder that communicates with reader 44 and then access room 30 using the key to unlock lock 52 of door 46. A person with a intermediate level of clearance may also access the entryway of the building through door 38 or through door 34 by using the security key case containing a proximity access transponder that communicates with readers 44 and 40, respectively, and then access the hallway 22 through door 36 by using the same security key case containing a proximity access transponder that communicates with reader 42. This intermediate level clearance person's key may then unlock door 48 and/or door 50 via locks 54 and 56, respectively. A person with the highest level of clearance may also access the same areas of the facility 15 as the intermediate person, but also be able to access room 28 using a security key case containing a proximity access transponder that communicates with reader 62 and key that unlocks lock 60.

In some embodiments, the security key case of the people with intermediate and the highest level of clearance may contain only one proximity access transponder having a single unique code, for example a single number sequence, that communicates with the respective increasing clearance level of proximity access transponder readers. For example, while the proximity access transponder of the person with the highest level of clearance would have one code that allows the proximity access transponder to communicate with all of the proximity access transponder readers 40, 42, 44, and 62, the proximity access transponder of the person with intermediate level of clearance would have a different code that allows the proximity access transponder to communicate with all of the same proximity access transponder readers except reader 62, and the person with lowest level of clearance has still another code that allows the proximity access transponder to communicate with only proximity access transponder reader 44. Alternatively, the proximity access transponder may have more than one unique code, which allows one code to communicate with one level of proximity access transponder readers, e.g. reader 44, and the same proximity access transponder having another code to communicate with a higher level of proximity access transponder readers, e.g. reader 42. In some alternative embodiments, the security key case may contain the same number of proximity access transponders as the proximity access transponder readers for the areas the person is authorized to access. For example, the security key case of the person with the highest level of clearance described above would have separate proximity access transponders for each of the proximity access transponder readers 40, 42, 44, and 62. In still some other alternative embodiments, the security key case may contain a combination of the foregoing. For example, the security key case of the person with the highest level of clearance may have two proximity access transponders, the first proximity access transponder having two unique codes, one code allowing the proximity access transponder to communicate with proximity access transponder readers 40 and 44 and the second unique code allowing the proximity access transponder to communicate with proximity access transponder reader 42; and then a second proximity access transponder with one unique code allowing the second proximity access transponder to communicate only with proximity access transponder reader 62. As illustrated from the preceding, there is a plethora of various combinations that one of ordinary skill in the art may utilize for access control.

In some embodiments, the security key case containing the key and proximity access transponder may be used to access only certain level(s) of a multi-level facility and then only certain areas within those level(s). For example, in order for a person to be able to access a specified level(s) of a facility via an elevator, the person must first use the security key case containing the proximity access transponder to communicate with a proximity access transponder reader in the elevator car before the pushing of the respective floor's button is recognized by the elevator. In addition, the person's security key case containing the proximity access transponder may allow access to the same level(s) of a facility while denying access to other access-restricted level(s). The same security key case containing the proximity access transponder may also be used to access the same allowed level(s) in the respective facility via the stairwell by communicating with a proximity access transponder reader located next to the door on the interior side of the stairwell. Once the person arrives at the authorized level(s), the room(s), office(s), laboratories, etc. located on that level(s) may contain another proximity access transponder reader, a lock to be unlocked by the key portion of the security key case, or a combination thereof. In another example, guests on a cruise ship may have access to various areas of the ship depending upon the type of access the guest purchased. Guests purchasing unrestricted access to the ship's accommodations would have a security key case containing a proximity access transponder with a different code than a guest purchasing a lower access trip. The key portion of the security key case would allow both guests to have access to their respective rooms.

In some embodiments, the security key case containing the key and proximity access transponder may be used on a single device. For example, for access control to a computer, the user may access the computer by inserting the key portion of the security key case into a lock and the lock will only be allowed to be turned to the unlocked position if the code of the proximity access transponder communicates with a proximity access transponder reader also located on the computer. The code of the proximity access transponder may alternatively or additionally communicate with the proximity access transponder on the computer and restrict access to the level of authorization the user has to computer files located in the computer and/or the computer network, the level of authorization of access to subject matter on the internet, and/or the level of authorization of software the user is authorized to use. In another example, the ignition of a vehicle may require the key portion of the security key case and the proximity access transponder communicating with a proximity access transponder reader before the vehicle can be started.

In some embodiments, the security key case containing the proximity access transponder is used to access at least one area of a limited-access area and the key is used to access a device. For example, a person may use the key portion of the security key case for their vehicle and the proximity access transponder to communicate with the proximity access transponder reader located at the person's front entryway of their dwelling. In another example, the key portion of the security key case may be used for a person's vehicle and the proximity access transponder may be used to communicate with a proximity access transponder reader at the gate of a restricted parking area.

In some embodiments, the security key case may be used for various combinations of facilities and/or devices. For example, the key portion of the security key case may be used for a person's vehicle while a single proximity access transponder or multiple proximity access transponders communicate with the respective proximity access transponder readers at a person's work, dwelling, exercise facility, and/or limited parking area. A single proximity access transponder may be programmed to have more than one code allowing the user to access these various facilities. Alternatively, more than one proximity access transponder in the security key case may be utilized to allow the user to access these various facilities.

A security key case is the combination of the key, the transponder, and the shell that unifies the key and the transponder, and may also include other features, e.g., an adapter to adapt variously sized keys to the shell. An example of the shells for the security key case is shown in FIGS. 2 and 3. FIGS. 2A-2C and 3A-3C have shell 70 with symmetrical members 72 and 74 joined by hinge 75. Members 72, 74 have key head ridges 76, 77 that cooperate with each other to receive a head portion of a key. Ridges 77, 79 cooperate to provide additional structure to shell 70, e.g., to resist compression, and may further be used to cooperate with mounting of a proximity access transponder (not shown). Flanges 80, 81 cooperate with each other to interlock and secure the shell in a closed position. Tab 82 cooperates with slot 84 to lock shell 70 closed in the closed position. Slot 86 is open when the shell is empty and receives a shank portion of a key. FIG. 2B shows member 74 in the open position and, as indicated by Arrow B, being folded into the closed position. FIG. 2C shows shell 70 in the closed position. FIG. 3A shows shell 70 open, with FIG. 3B showing the shell from the vantage point indicated by arrow B in FIG. 3A. FIG. 3C shows shell 70 from the vantage point indicated by arrow C in FIG. 3B.

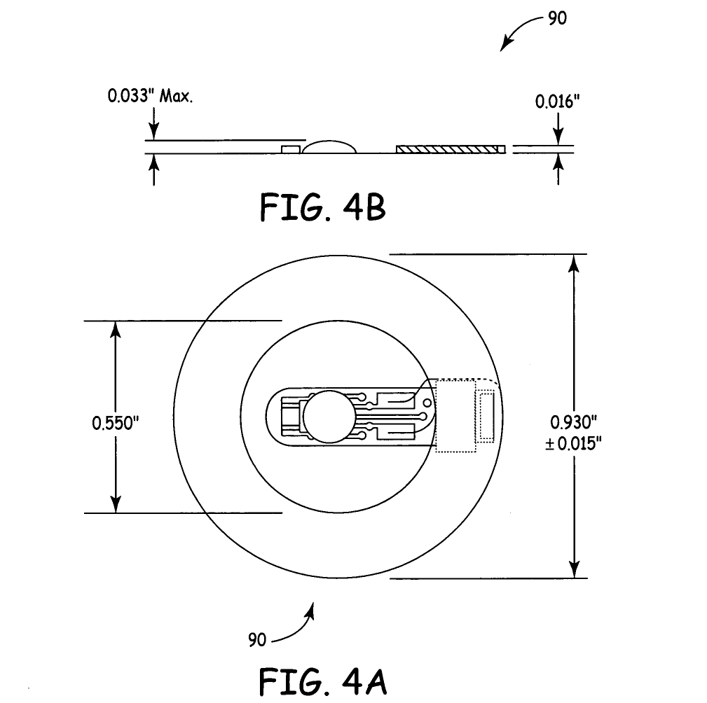

FIGS. 4A and 4B show a proximity access transponder 90 suitable for use with shell 70. This particular transponder can be purchased at HID Corporation in Irvine, California. Those of ordinary skill in these arts, after reading this application, will appreciate that other types of transponders may be obtained and used to make the embodiments described herein.

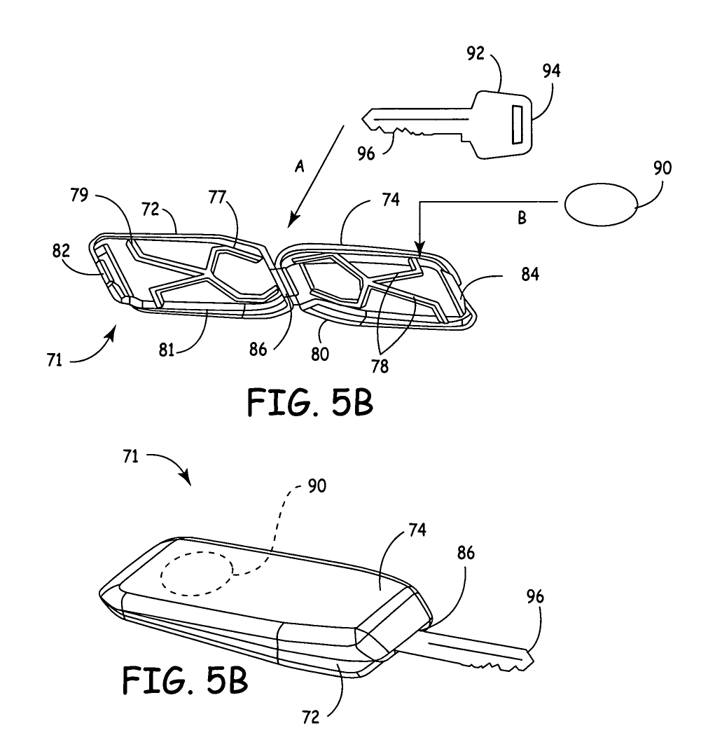

FIGS. 5A and 5B show secure key case 71 with shell 70, key 92 with head portion 94 and teeth 96 being introduced into slot 86 as indicated by arrow A. Transponder 90 is placed into shell 70, as indicated by arrow B of FIG. 5A, where it is supported by ribs 77, 78, which may be sized to create an opening that the transponder fits into, e.g., by making the ribs so that they have portions that do not touch each other and instead touch the transponder when it is in place and shell 70 is closed. Or transponder 90 may be secured, for example, by glue, tape, or adhesive. Further, transponder 90 may be placed into another packing material, e.g., paper, foam, or plastic, that presses against transponder 90 when shell 70 is closed so as to secure the transponder. Similarly, another packing material, e.g., paper, foam, or plastic, may be used to secure key head 94 to prevent its movement when shell 70 is closed. Or glue, tape, or adhesive could be used to further secure key head. Shell 70 is closed by folding along hinge 75, with teeth 96 projecting outside the shell, with key head 94 and transponder 90 being inside the shell. Flanges 80, 81 cooperate to fit each other in the closed position.

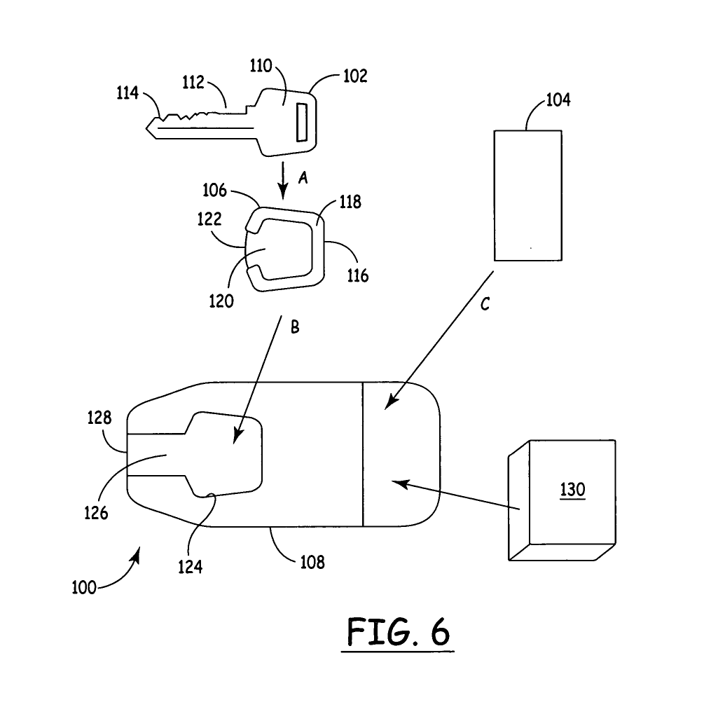

FIG. 6 depicts a security key case 100 with key 102, proximity access transponder 104, adapter 106, and shell member 108 that defines a portion of the shell (not shown in entirety). The key has head portion 110, shank 112, and teeth 114. The adapter has outer portion 116, and rim 118 that defines seat 120 and opening 122. The shell member 108 has shell rim 124 that defines shell seat 126 and opening 128. Opening 128 cooperates with another member of the shell to define a slot (not shown) that receives the shank of the key. The case is assembled by placing transponder 104 into shell member 108 and optional packing 130 on either side of member 108. Key head 110 is placed into adapter seat 120 as indicated by arrow A and the adapter is placed into shell seat 126 as indicated by arrow B. Shank 112 of key 102 projects from the shell, with teeth 114 being exposed to fit into a lock. Another member (not shown) is fit onto shell member 108 to complete the assembly.

The shell may thus be used in combination with an adapter for adapting a key head to the shell. In some embodiments, the shell has a pocket shaped to receive the adapter, wherein the adapter has a portion that fits into the pocket and another portion for receiving the key. A user may put the key head into the adapter and place the adapter into the shell. In some embodiments, an adapter is used for every key, with a variety of adapters being available for variously used key types.

A shell may be configured in a variety of ways, as will be apparent to those of ordinary skill after reading this application. For instance, the shell could be one piece or in two or more pieces. And, for instance, the tab-and-slot locking mechanism, which is reversibly lockable and unlockable, could be replaced by a glued seam, a collet, a mortise-and-tenon or other suitable means, including means that are not reversibly lockable.

In some embodiments, the shell is provided to a manager or end user without the key and/or without the transponder. The shell is reversibly lockable so that the transponders and keys may be assembled at the site of the facility, e.g., by the apartment manager. The shell may further be provided with any combination of: key blanks, adapters to fit key heads of key blanks to the shell, proximity access transponders, sets of proximity access transponders with each set having at least one code selected to give access to particular areas wherein each set differs from the other sets by having unique code(s), packaging materials for fitting the transponder and/or key into the shell, and adhesives for use in assembly of the security access case.

A key, as that term is used herein, refers to a device used to open a lock and has teeth and/or grooves which fit the shape of the lock and can open the correct lock by (usually) being turned in the lock housing. The term key also includes a tubular key that is designed to open a tubular pin tumbler lock. It has a hollow, cylindrical shaft and a number of grooves of varying length at the end of the shaft. The grooves are approximately parallel to the shaft and allow the pins in the lock to slide to the end of the groove.

The shell is preferably made of a plastic material, e.g., polyethylene, polypropylene, polycarbonate, polyetherether ketone (PEEK), rubber, an elastomer (e.g. SANTOPRENE), silicone, or polyvinylchloride. In light of the contents of this application, it may be helpful in some circumstances to incorporate other features described in certain other patent applications, which are hereby incorporated by reference herein: U.S. Pat. Nos. 5,433,096, 5,732,579, 5,764,156, 6,164,101, 6,427,504, and 6,637,245.

In some embodiments, the shell is rigid, meaning that the typical force applied by a user when turning a typical key in a typical lock allows for essentially no torsional strain relative to an axis through the center of the shank of the key and parallel to the teeth of the key. The rigid shell does not allow the user to twist the shell and thereby strain the transponder in the shell. In contrast, a nonrigid shell, depending on its design, may tend to twist when the user turns the key in the lock so that the twisting motion bends the transponder and causes it to fail prematurely. Thus a shell made of a high strength engineering material, e.g., PEEK, tends to be rigid. Further, for example, internal ribs may be used to impart rigidity to the shell, with the ribs reinforcing the strength of the shell and preventing torsional or other bending forces.

1. A security key case comprising a unitary plastic shell that encases at least one proximity access transponder for communication with at least one proximity access transponder reader and a head of a key, with teeth of the key projecting from the shell for unlocking a lock.

2. The case of claim 1 wherein the shell comprises two members joined by a hinge, wherein the two members cooperate with each other to encase the proximity access transponder and the head of the key.

3. The case of claim 2 wherein the two members are reversibly locked to each other.

4. The case of claim 2 wherein the two members are reversibly locked to each other by a tab on one of the members that fits into a slot on the other of the members.

5. The case of claim 1 wherein the shell is rigid.

6. The case of claim 1 further comprising an adapter for the head of the key, with the shell being configured to seat the adapter.

7. A method of making a security key case comprising:
providing a shell having two members that define a slot, a key having a head portion and a shaft with teeth for unlocking a lock, and at least one proximity access transponder for communication with at least one proximity access transponder reader,
placing the proximity access transponder into the shell,
placing the shaft into the shell with the shaft being disposed in the slot, and
closing the shell to encase the proximity access transponder and the head of the key, with teeth of the key projecting from the shell.

8. The method of claim 7 wherein the two members are hingedly connected.

9. The method of claim 7 further comprising reversibly locking the two members to each other when the shell is in the closed position.

10. The method of claim 7 wherein the shell is rigid.

11. A security system comprising at least one proximity access transponder reader that controls access to a common area of a facility, a lock that controls access from the common area into a limited access area, and a control assembly comprising a shell that encases at least one proximity access transponder that communicates with the proximity access transponder reader to allow access into the common area and a head of a key that fits the lock to allow access into the limited access area.

12. The system of claim 11 wherein the shell comprises two members that define a slot to receive a shank of the key.

13. The system of claim 12 wherein the two members are hingedly connected.

14. The system of claim 11 wherein the two members are reversibly locked to each other.

15. The system of claim 11 further comprising an adapter for adapting the head of the key to a seat in the shell.

16. A method of assembling a security system comprising:
providing at least one proximity access transponder reader that controls access to a common area of a facility, a lock that controls access from the common area into a limited access area, and a control assembly comprising a shell that encases at least one proximity access transponder that communicates with the proximity access transponder reader to allow access into the common area,
placing a head of a key that fits the lock into the shell,
placing the proximity access transponder that communicates with the proximity access transponder reader into the shell, and
reversibly locking the shell.

17. The method of claim 16 further comprising placing onto the head of the key an adapter for adapting the head of the key to the shell, and placing the adapter into a seat in the shell.

18. The method of claim 16 further comprising using the proximity access transponder to access the common area and then using the key to access the limited access area.

19. The method of claim 16 wherein the facility is an apartment building, hotel, ship, office building, storage facility, housing development, elevator, single-family home, or gated community.

20. The method of claim 16 wherein the limited access area is an apartment or condominium and the common area comprises a hallway that provides access to the lock.
